(19) United States
(12) Patent Application Publication
(10) Pub. No.: US 2012/0331527 A1
(43) Pub. Date: Dec. 27, 2012

(54) MULTI-LAYER, GEOLOCATION-BASED NETWORK RESOURCE ACCESS AND PERMISSIONS

(75) Inventors: Ryan D. Walters, Falls Church, VA (US); Rodney D. Caudle, Kansas City, MO (US); Timothy L. Decamp, Vienna, VA (US)

(73) Assignee: TerraWi, Inc., Falls Church, VA (US)

(21) Appl. No.: 13/166,223

(22) Filed: Jun. 22, 2011

(51) Int. Cl. G06F 21/00; G06F 15/16

(52) U.S. Cl. 726/4; 726/5; 709/206

(57) ABSTRACT

In some embodiments, a non-transitory processor-readable medium stores code representing instructions configured to cause a processor to receive, from a mobile device, a first signal including a request to execute a command at a server. The code further represents instructions configured to cause the processor to receive, from the mobile device, a second signal including a user credential associated with a user account and determine, based on the user credential, a user role associated with the user account. The code further represents instructions configured to cause the processor to receive, from the mobile device, a third signal indicating a geolocation of the mobile device. The code further represents instructions configured to cause the processor to determine, based at least on the user role and the geolocation, whether the user account is authorized to execute the command. The code further represents instructions configured to cause the processor to, when the user account is authorized to execute the command, send a fourth signal such that the command is executed at the server.

### BACKGROUND

Some embodiments described herein relate generally to geolocation-based network resource access, and more particularly to methods and apparatus for management of network resource access based on a current geolocation of a mobile device.

In many computer networks, known network resource access schemes and/or protocols ensure that only specified network users and/or client devices are granted access to specified network resources. Such approaches often restrict access to one or more given folders, files, databases, applications, processes, functions, and/or other network resources based on a predetermined user role, user group, access level, etc. For example, in many such computer networks, access to any or all of the above can be based on a client device ID or other property of the client device.

While such methods may successfully restrict user and/or client device access based on one or more of the above-described criteria, they generally fail to more-granularly regulate access (e.g., to individual portions of data and/or specific commands) based on a current geolocation of a user device (e.g., a mobile computing device). Thus, such methods are incapable of granting access to a specific network resource exclusively to devices within a given geographic region (e.g., a workplace, a predetermined “safe zone”, etc.). Therefore, a need exists for methods and apparatus to restrict access to network data portions and/or network application commands based on a current geolocation of a mobile device.

### SUMMARY

In some embodiments, a non-transitory processor-readable medium stores code representing instructions configured to cause a processor to receive, from a mobile device, a first signal including a request to execute a command at a server. The code further represents instructions configured to cause the processor to receive, from the mobile device, a second signal including a user credential associated with a user account and determine, based on the user credential, a user role associated with the user account. The code further represents instructions configured to cause the processor to receive, from the mobile device, a third signal indicating a geolocation of the mobile device. The code further represents instructions configured to cause the processor to determine, based at least on the user role and the geolocation, whether the user account is authorized to execute the command. The code further represents instructions configured to cause the processor to, when the user account is authorized to execute the command, send a fourth signal such that the command is executed at the server.

### BRIEF DESCRIPTION OF THE FIGURES

FIG. 1 is a schematic block diagram that illustrates a geolocation-based network access system, according to an embodiment.

FIG. 2 is a schematic diagram that illustrates a mobile device having multiple hardware components and storing multiple software modules, including a geolocation module, according to another embodiment.

FIG. 3 is a schematic diagram that illustrates an access server storing an authentication module and a permissions module, according to another embodiment.

FIG. 4 is a schematic block diagram that illustrates a geolocation-based network access system, according to another embodiment.

FIG. 5 is a flow chart describing a method of determining whether a mobile device is authorized to access a protected resource based on the mobile device's current geolocation, according to another embodiment.

FIG. 6 is a flow chart describing a method of enabling functionality of a mobile device based at least in part on a current geolocation of the mobile device, according to another embodiment.

### DETAILED DESCRIPTION

In some embodiments, a mobile device can request access to a protected network resource included in a private network. The mobile device can be, for example, a cellular telephone (e.g., a smartphone), a tablet computing device, a laptop, notebook, or netbook computer, etc. In some embodiments, the mobile device can include the request in one or more signals sent to an access server of the private network via a public wireless network (e.g., a commercial cellular telephone network, a commercial wireless broadband network, etc.). The access server can be and/or include one or more hardware modules and/or software modules (stored and/or executing in hardware) configured to regulate access of client devices to the private network. The private network can be a local area network (LAN), wide area network (WAN), intranet, extranet, etc. associated with a given entity or entities. The private network can optionally include one or more databases, application servers, routers, switches, and/or the like. The protected network resource can be, for example, a file, folder, data portion, data store, database, database record, physical component or device, memory, command, instruction, application, etc.

In response to the access request received from the mobile device, the access server can determine whether a user of the mobile device is currently authorized to access the requested protected network resource. For example, the access server can request and receive, from the mobile device: (1) one or more user authentication credentials associated with a user account of the user, and (2) one or more geographic coordinates indicating a current geolocation of the mobile device. Based at least in part on the received authentication credentials and the current geolocation of the mobile device, the access server can determine whether the user of the mobile device is currently authorized to access the protected network resource.

To determine whether the user of the mobile device is currently authorized to access the protected network resource, the access server can perform one or more calculations and/or send one or more queries to one or more data stores and/or databases associated with the private network. For example, the access server can send a query to determine a user role, user group and/or other access setting associated with the user account of the user to determine if that user account is authorized to access the protected resource. The access server can also send a second query to a same or different data store or database, the second query configured to determine one or more geographic regions within which a given mobile device may be authorized to access the protected network resource. Based at least in part on the results associated with this second query (e.g., a database response and/or result set), the access server can determine whether the current geolocation of the mobile device (based on the received one or more geographic coordinates) is located within the one or more authorized geographic regions.

If the access server determines (1) that the user account is authorized to access the protected resource (based on, e.g., a user role, user group, and/or other account setting associated with the user account), and (2) that the current geolocation of the mobile device is included in at least one geographic region associated with the protected network resource, the access server can send an indication of the same to the mobile device. At this point, the mobile device can send a request, through the private network, to access the protected resource, and receive, via the private network, a response including at least a portion of the protected resource. Alternatively, in some embodiments, upon determining (1) and (2) above, the access server can send a request to a network server at which the protected network resource is stored (or at which the protected network resource, if a command, instruction, function, or application, may be executed). Based at least in part on this request received from the access server, the network server storing the protected network resource can send at least a portion of the protected resource, via the private network, to the mobile device. If the protected resource is a command, instruction, or function, the network server can accordingly execute the command, instruction or function, and send one or more results of the same, via the private network, to the mobile device.

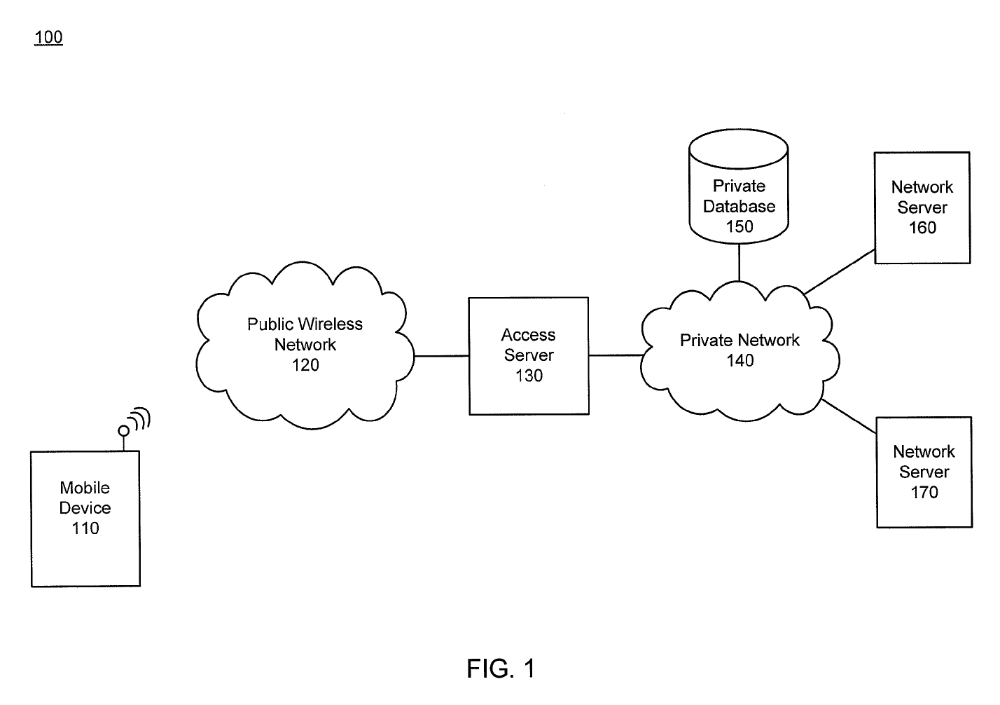

FIG. 1 is a schematic block diagram that illustrates a geolocation-based network access system, according to an embodiment. More specifically, FIG. 1 illustrates a network access system 100 that includes a mobile device 110 operatively coupled to an access server 130 via a public wireless network 120. The access server 130 is in communication with a private network 140, which includes and/or is physically and/or operatively coupled to each of a private database 150, a network server 160 and a network server 170.

The mobile device 110 can be any valid mobile computing device capable of (1) determining its own current geolocation, and (2) exchanging information with the private network 140 via the public wireless network 120. For example, the mobile device 110 can be a mobile telephone (e.g., a cellular telephone, a smartphone, a satellite telephone) and/or other mobile computing device (e.g., a tablet computing device, a personal digital assistant (PDA), etc.). Although not shown in FIG. 1, the mobile device 110 can have or include one or more antennae and/or network cards (e.g., cellular network communication cards, wireless Ethernet cards, etc.) configured to enable the mobile device 110 to exchange information via one or more wireless networks, such as the public wireless network 120. Although also not shown in FIG. 1, the mobile device 110 can have or include one or more hardware and/or software modules stored and/or executing in hardware) configured to determine a current geolocation of the mobile device 110. For example, the mobile device 110 can have, include and/or be coupled to one or more Global Positioning System (GPS) modules and/or other geolocation modules capable of communicating with one or more GPS satellites, cellular network towers, etc. (not shown in FIG. 1) to determine a current geolocation of the mobile device 110. In some embodiments, the mobile device 110 can include, be operatively coupled to and/or be physically coupled to one or more input devices and/or peripheral devices (e.g., a display, a touchscreen, a keypad or keyboard, a pointer device, a stylus, etc.). Although not shown in FIG. 1, in some embodiments, multiple mobile devices, similar to the mobile device 110, can be operatively coupled (e.g., wirelessly coupled) to the public wireless network 120, and/or to one or more elements of the private network 140 (via the public wireless network 120).

The public wireless network 120 can be any public wireless network configured to allow two or more client, server, peripheral or other devices to exchange data wirelessly. For example, the public wireless network 120 can be a cellular telephone and/or data network (e.g., a wireless broadband network) configured to transmit data according to any of the Global System for Mobile (GSM), GSM/General Packet Radio Service (GPRS), GSM Enhanced Data Rates for GSM Evolution (EDGE), Code Division Multiple Access (CDMA), CDMA2000, WCDMA (Wideband CDMA), Time Division Multiple Access (TDMA), IEEE 802.11x (“Wi-Fi”), 802.16x (“WiMax”), and/or Long Term Evolution (LTE) standards, and/or one or more other similar standards or protocols. In some embodiments, the public wireless network 120 can be associated with one or more public or private wireless network providers or administrators. For example, the public wireless network 120 can be associated with, constructed, configured and/or administered by a consumer cellular telephone entity, a wireless data provider (e.g., a wireless broadband provider), an Internet Service Provider (ISP), a governmental agency, etc.

The access server 130 can be any combination of hardware and/or software (stored and/or executing in hardware) configured to (1) authenticate a user of the mobile device 110, and (2) grant or deny access to one or more network resources requested by the mobile device 110 based at least in part on access permissions associated with the mobile device 110 and/or a user thereof. Said differently, the access server 130 can be any device configured to receive requests to access one or more resources of the private network 140 and grant such access only to a valid user account executing at a requesting mobile device that is currently located within a predetermined geographic region associated with the requested one or more network resources. In some embodiments, the access server 130 can be configured to grant full access to the private network 140 to authenticated users, and to grant limited access to the private network 140 to unauthenticated users and/or other individuals.

In some embodiments, the access server 130 can include one or more network cards (not shown in FIG. 1), such as one or more Ethernet, Fibre Channel, or other network cards configured to exchange packets, cells and/or other data package formats. As shown in FIG. 1, the access server 130 can be physically and/or operatively coupled to each of the public wireless network 120 and the private network 140. In some embodiments, the access server 130 can be situated in a same physical location as one or more elements of the private network 140 (e.g., the private database 150, the network server 160, the network server 170). The access server 130 can also optionally be included in a same physical device or chassis as one or more of the private database 150, the network server 160 and/or the network server 170. Although not shown in FIG. 1, in some embodiments, the functionality of access server 130 can be distributed across two or more physical devices, each physically and/or operatively coupled to the private network 140 and the public wireless network 120.

The private network 140 can be any private network configured to allow two or more client and/or server devices to exchange information to a restricted set of devices and/or users. For example, the private network 140 can be a local area network (LAN), a wide area network (WAN), an intranet, an extranet, or other private network type. In some embodiments, the private network 140 can include and/or be physically coupled and/or operatively coupled to one or more client, server and/or networking devices (e.g., client desktop computers, client mobile devices, database servers, rack-mounted servers, storage area network (SAN) devices, network switches, network routers, etc.) (not shown in FIG. 1). As shown in FIG. 1, the private network 140 can include or be operatively coupled to the access server 130, the private database 150, the network server 160, and the network server 170. Although not shown in FIG. 1, access to the private network 140 (and/or one or more resources thereof) can be restricted based on one or more rules and/or requirements. More specifically, access to the private network 140 (and/or one or more resources thereof) can be managed by the access server 130, which can administer one or more authentication, validation and/or other policies designed to restrict access to the private network 140 based at least in part on, for example, a current geolocation of a requesting device (e.g., the mobile device 110).

The private database 150 can be any device (e.g., a network server) storing one or more databases. As shown in FIG. 1, the private database 150 can be operatively coupled to the access server 130, the network server 160 and the network server 170 via the private network 140. Although not shown in FIG. 1, in some embodiments, the private network 140 can be coupled to and/or include multiple private databases similar to the private database 150. In some embodiments, the private database 150 can include one or more relational databases including one or more relational database tables. For example, the private database 150 can include one or more Oracle, Microsoft SQL Server, MySQL, PostgreSQL, Informix and/or other databases storing contact, messaging, document, multimedia, permissions, credentials, access history, and/or other data associated with a user of the mobile device 110 and/or the mobile device 110 itself. Although not shown in FIG. 1, the private database 150 can store information accessible only to devices authorized and validated for interaction with the private network 140. In some embodiments, the private database 150 can store some information accessible only to authenticated users, and can store other information accessible to unauthenticated users and/or other individuals. In some embodiments, access to one or more databases, database tables, database columns and/or database rows of the private database 150 can be restricted, by the access server 130, to users and/or devices conforming to a predetermined set of requirements and/or having a predetermined configuration and/or set of credentials. More specifically, access to any of the above-described network resources can be restricted to one or more predetermined client devices (e.g., the mobile device 110) currently located in one or more geographic areas associated therewith.

The network server 160 and the network server 170 can be any combination of hardware and/or software configured to provide resources to client devices accessing the private network 140. As shown in FIG. 1, the network server 160 and the network server 170 can be operatively coupled to the private database 150, to the access server 130, and to one another via the private network 140. Although not shown in FIG. 1, in some embodiments, the private network 140 can include fewer or more than two network servers similar to the network servers 160 and 170. Each of the network servers 160 and 170 can optionally be configured to store and execute one or more network applications or services (e.g., cloud-based applications, server-side applications, etc.) for access by the mobile device 110. For example, the network server 160 can execute an e-mail, productivity (e.g., contacts, calendar, word-processing), or other application for access by the mobile device 110 via the public wireless network 120 and the private network 140. Alternatively or additionally, the network server 170 can host an imaging, image-editing, data management, or other cloud-based application or applications. In some embodiments, any or all of the above-described applications can perform one or more commands in response to a request and/or instruction received from a user of a client device (e.g., the mobile device 110) via the private network 140. In such embodiments, each such command can be associated with a predetermined client device or set of client devices, a predetermined access level or group, a predetermined user or set of users, and/or a predetermined geographic region or area. In this manner, the access server 130 and the network servers 160 and 170 can restrict execution of one or more application commands to predetermined contexts and/or scenarios.

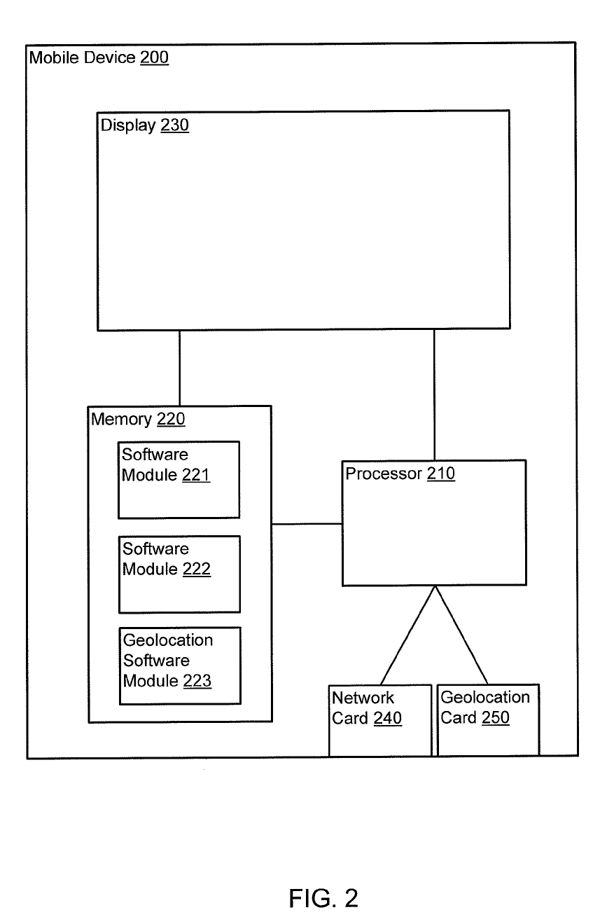

FIG. 2 is a schematic diagram that illustrates a mobile device having multiple hardware components and storing multiple software modules, including a geolocation module, according to another embodiment. More specifically, FIG. 2 is a system block diagram of a mobile device 200, similar to the mobile devices 110 described in connection with FIG. 1 above. The mobile device 200 includes a processor 210 operatively coupled to a memory 220, to a display 230, to a network card 240 and to a geolocation card 250. As shown in FIG. 2, the memory 220 includes three software modules: a software module 221, a software module 222, and a geolocation software module 223. In some embodiments, the mobile device 200 can include additional hardware modules and/or software modules (executing in hardware or stored in memory) not shown in FIG. 2. For example, the mobile device 200 can include one or more input devices and/or peripherals, one or more data input ports, etc.

The processor 210 can be any processor (e.g., a central processing unit (CPU), an application-specific integrated circuit (ASIC), and/or a field programmable gate array (FPGA)) configured to execute one or more instructions received from, for example, the memory 220. In some embodiments, the processor 210 can be a mobile device microprocessor specifically designed to execute on or within a mobile device (e.g., Reduced Instruction Set computing (RISC) processor). As shown in FIG. 2, the processor 210 can be in communication with any of the memory 220, the display 230, the network card 240 and the geolocation card 250. In some embodiments, the processor 210 can accordingly send information (e.g., data, instructions and/or network data packets) to and/or receive information from any of the memory 220, the display 230, the network card 240 and the geolocation card 250.

The memory 220 can be any memory (e.g., a RAM, a ROM, a hard disk drive, an optical drive, other removable media) configured to store information (e.g., a mobile operating system, one or more software applications, media content, text content, contact information, etc.). As shown in FIG. 2, the memory 220 can include a software module 221, a software module 222 and a geolocation software module 223. In some embodiments, the memory 220 can include instructions (e.g., code) sufficient to define and/or execute the software module 221, the software module 222 and the geolocation software module 223. Each of the software modules 221 and 222 can be any installed software program (e.g., a software module, package, class, driver, applet, etc.). Either or both of the software module 221 and the software module 222 can be a mobile device application (“app”), such as a messaging, contacts, calendar, productivity, multimedia, navigation, shopping, or other type of app. In some instances, either or both of the software module 221 and the software module 222 can be or can include malicious software code and/or functionality (e.g., a virus, a worm, or a malware, adware, and/or spyware module), and/or non-malicious software code and/or functionality. In some embodiments, either or both of the software modules 221 and the software module 222 can be configured to execute one or more commands and/or send an instruction via a wireless network (e.g., the public network 120 and/or the private network 140 of FIG. 1) such that the one or more commands is remotely executed at a network server (e.g., the network server 160 and/or the network server 170 of FIG. 1).

The geolocation software module 223 can be a software module configured to calculate, receive and/or determine a current geolocation of the mobile device 200 based at least in part on information received from the geolocation card 250. As shown in FIG. 2, the geolocation software module 223 can be included in the memory 220, and thus can be accessed by the processor 210. In some embodiments, the geolocation software module 223 can determine (e.g., obtain, calculate, look-up, retrieve, etc.) one or more geographic coordinates (e.g., longitude and/or latitude coordinates) associated with and/or based at least in part on a current physical location of the mobile device 200 as determined by the geolocation card 250.

Based at least in part on the geolocation information associated with the mobile device 200, the geolocation software module 223 can determine whether one or more predefined attributes, functions, features, etc. of one or more components, modules and/or applications of the mobile device 200 (e.g., the software module 221) are currently accessible to a user of the mobile device 200. Alternatively or additionally, the geolocation software module 223 can send the geolocation information to another hardware and/or software module of the mobile device 200 to enable that module to determine whether one or more attributes, functions, features, etc. thereof is currently accessible to a user of the mobile device 200.

Alternatively or additionally, in some embodiments, the geolocation software module 223 can send the geolocation information to another module of the mobile device 200 (e.g., the software module 222) for inclusion in a request to be sent to a network server via a wireless or mobile network. The request can include, for example, a request to execute a specified command at the network server, a request to access a specified portion of data (from, e.g., a network database), etc. In some embodiments, the request can be granted or denied by the network server based at least in part on the geolocation information. In such embodiments, the mobile device 200 can receive, in response to the request, a response from the network server indicating whether the requested command can be executed and/or whether the requested data can be accessed by the mobile device 200. Based at least in part on a received affirmative response, the mobile device 200 can accordingly access the requested network resource and/or initiate the requested network server command.

The memory 220 can also alternatively store one or more resources (e.g., software resources such as drivers, code libraries, etc.) (not shown in FIG. 2) associated with the software modules 221-222 and/or the geolocation software module 223. In some embodiments, the memory 220 can further store device identifier (ID), software module ID, hardware component ID, current geolocation information, previous geolocation information and/or other information to be received and/or calculated by the geolocation software module 223.

The display 230 can be any display configured to display information to a user of the mobile device 200. For example, the display 230 can be a liquid crystal display (LCD), a light-emitting diode (LED) display, an organic light-emitting diode (OLED) display, a touchscreen, a tactile display, or other screen or display type. As shown in FIG. 2, the display 230 can receive information from the memory 220 and/or the processor 210. Although not shown in FIG. 2, in some embodiments the display 230 can receive information from the processor 210 and/or the memory 220 via one or more intermediary modules, such as one or more embedded hardware modules (e.g., a video hardware module). In some embodiments, the display 230 can display information associated with one or more of the software modules 221-222 and/or the geolocation software module 223.

The network card 240 can be a hardware module (e.g., a wired and/or wireless Ethernet card, a cellular network interface card) configured to transmit information (e.g., data packets, cells, etc.) from and receive information at the mobile device 200. As shown in FIG. 2, the network card 240 can be operatively and/or physically coupled to the processor 210. In this manner, the processor 210 can, via the network card 240, exchange information with one or more other devices via a network (e.g. the public network 120 discussed in connection with FIG. 1 above).

The geolocation card 250 can be a hardware module (e.g., an antenna) configured to exchange signals and/or information with one or more GPS satellites, cellular network towers, etc. to receive and/or determine current spatial coordinates of the mobile device 200. For example, the geolocation card 250 can be a GPS card configured to receive longitude, latitude and/or altitude coordinates indicating a current physical location and/or position of the mobile device 200. In some embodiments, the geolocation card 250 can be configured to determine a current orientation (e.g., a compass direction) of the mobile device 200. In some embodiments, the geolocation card 250 can be configured to transmit the received and/or determined spatial coordinate and/or other geolocation information to the processor 210 and/or to the geolocation software module 223 via the processor 210.

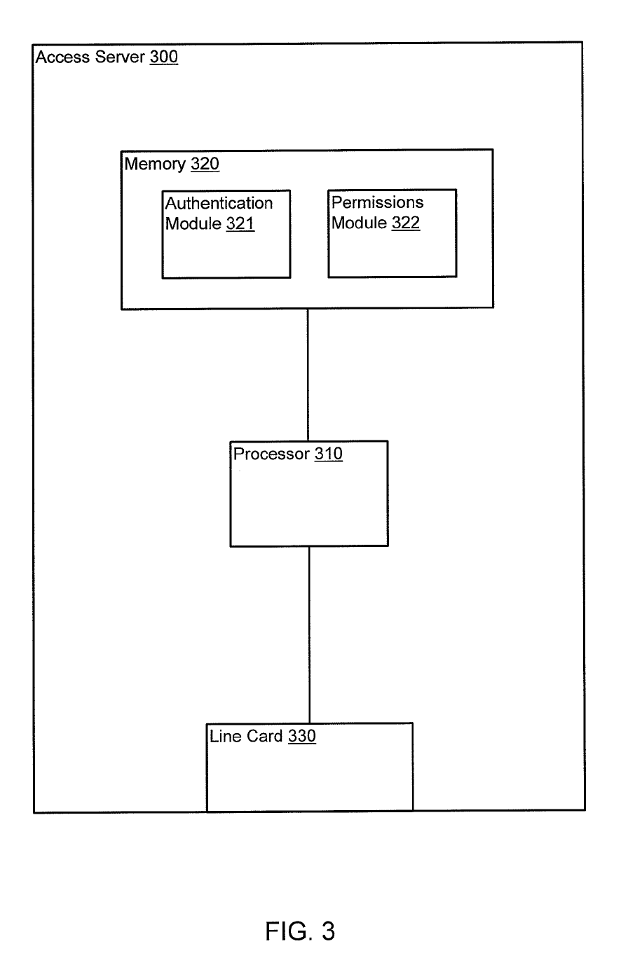

FIG. 3 is a schematic diagram that illustrates an access server storing an authentication module and a permissions module, according to another embodiment. More specifically, FIG. 3 is a system block diagram of an access server 300, similar to the access server 130 described in connection with FIG. 1 above. The access server 300 includes a processor 310 operatively coupled to a memory 320 and to a network card 330. As shown in FIG. 3, the memory 320 includes an authentication module 321 and a permissions module 322. In some embodiments, the access server 300 can include additional hardware modules and/or software modules (executing in hardware) not shown in FIG. 3. For example, the access server 300 can include one or more input devices and/or peripherals, one or more data input ports, etc.

The processor 310 can be any processor (e.g., a central processing unit (CPU), an application-specific integrated circuit (ASIC), or a field programmable gate array (FPGA)) configured to execute one or more instructions received from, for example, the memory 320. As shown in FIG. 3, the processor 310 can be in communication with any of the memory 320 and the network card 330. In some embodiments, the processor 310 can accordingly send information (e.g., data, instructions and/or network data packets) to and/or receive information from any of the memory 320 and the network card 330.

The memory 320 can be any memory (e.g., a RAM, a ROM, a hard disk drive, an optical drive, other removable media) configured to store information (e.g., a server operating system, a desktop operating system, one or software applications, etc.). As shown in FIG. 3, the memory 320 can include an authentication module 321 and a permissions module 322. In some embodiments, the memory 320 can include instructions (e.g., code) sufficient to define and/or execute the authentication module 321 and the permissions module 322. The memory 320 can also alternatively store one or more resources (e.g., software resources such as drivers, code libraries, etc.) associated with the authentication module 321 and/or the permissions module 322. In some embodiments, the memory 320 can further store current and/or previous hardware, software and/or software permission information associated with the mobile device.

The authentication module 321 can optionally be a software module configured to determine whether a user of a mobile device is valid, i.e., whether the user should be allowed to access at least a portion of a private network to which the access server 300 is coupled. For example, the authentication module 321 can be configured to receive login and/or other credentials associated with a user of a mobile device. In some embodiments, the credentials can be included in a signal received at the access server via a public access network. In some embodiments, the credentials can be received from a mobile device requesting access to at least a portion of a private network to which the access server 300 is coupled. Upon receipt of the credentials, the authentication module 321 can determine whether the credentials are associated with a valid user. To do so, the authentication module 321 can optionally exchange one or more signals with another hardware and/or software module included in the access server 300. Alternatively, the authentication module 321 can exchange one or more signals with a separate device coupled to the private network. The separate device can be, for example, any device (e.g., a network server) storing a database (e.g., the private database 150 of FIG. 1) storing login credentials associated with one or more valid users registered to access the private network.

The permissions module 322 can optionally be a software module configured to determine whether a requesting mobile device is authorized to access one or more indicated network resources (e.g., data, such as files, folders, database values; applications and/or application functions; server commands, etc.) associated with a private network to which the access server 300 is coupled and/or in which the access server 300 is included. In some embodiments, the permissions module 322 can receive, from a mobile device, a request to access a portion of the private network and/or a specified network resource (e.g., a protected resource such as a specified database, database column, database row, etc.). Alternatively, the permissions module 322 can receive the request from another module included in the access server 300 (e.g., the authentication module 321). The access request can optionally include device information, such as a device ID that uniquely identifies the mobile device and/or a current geolocation of the mobile device.

If the access request includes a request to access an indicated network resource that is associated with one or more specified geographic locations, areas and/or regions, the permissions module 322 can determine whether the received geolocation information falls within any of the specified geographic location, area and/or regions. To do so, the permissions module 322 can compare the received geolocation information to, for example, longitude and/or latitude coordinates associated with the indicated network resource. (These longitude and/or latitude coordinates can optionally be retrieved from one or more network servers and/or private databases associated with the private network to which the access server is coupled.) In such embodiments, if the permissions module 322 determines that the received geolocation information falls within at least one predefined geographic location, area and/or region associated with the requested network resource, the permissions module 322 can accordingly send a response signal to the mobile device indicating that access to the requested network resource has been granted. If the received geolocation information does not match or fall within any predefined geographic location, area and/or region associated with the requested network resource, the permissions module 322 can accordingly send a response signal to the mobile device indicating that access to the requested network resource has been denied.

In some embodiments, the access server 300 (via, e.g., the permissions module 322) can periodically send, to the mobile device, one or more subsequent requests for updated geolocation information of the mobile device. For example, the access server 300 can send a request for updated geolocation information to the mobile device according to a predetermined schedule, such as every minute, every 90 seconds, every 5 minutes, etc. Alternatively or additionally, in some embodiments, the mobile device can proactively send updated geolocation information to the access server 300. For example, the mobile device can send (e.g., “push”) updated geolocation information to the access server 300 whenever the mobile device determines that its own current geolocation has changed. In some embodiments, the mobile device can also or alternatively send updated geolocation information to the access server 300 according to a predetermined schedule as described above. In this manner, the access server 300 can determine at regular intervals whether the mobile device is still physically located in a geographic region associated with the indicated network resource. If, based on the updated geolocation information, the access server 300 determines that the mobile device is no longer physically located in a geographic region and/or area associated with the indicated network resource, the access server 300 can optionally send one or more signals to the mobile device configured to disable access to the indicated resource. For example, the access server 300 could send a signal configured to “freeze”, or temporarily disable access to and/or interaction with the indicated network resource, and send a subsequent signal configured to reenable such access if and when it receives subsequent updated geolocation information from the mobile device indicating a physical location included in a geographic region associated with the indicated network resource.

The network card 330 can be a hardware module (e.g., a wired and/or wireless Ethernet card, a cellular network interface card) configured to transmit information (e.g., data packets, cells, etc.) from and receive information at the access server 300. As shown in FIG. 3, the network card 330 can be operatively and/or physically coupled to the processor 310. In this manner, the processor 310 can, via the network card 330, exchange information with one or more other devices (e.g., a mobile device similar to the mobile device 110 of FIG. 1) via a network (e.g., a network similar to the public wireless network 120 of FIG. 1).

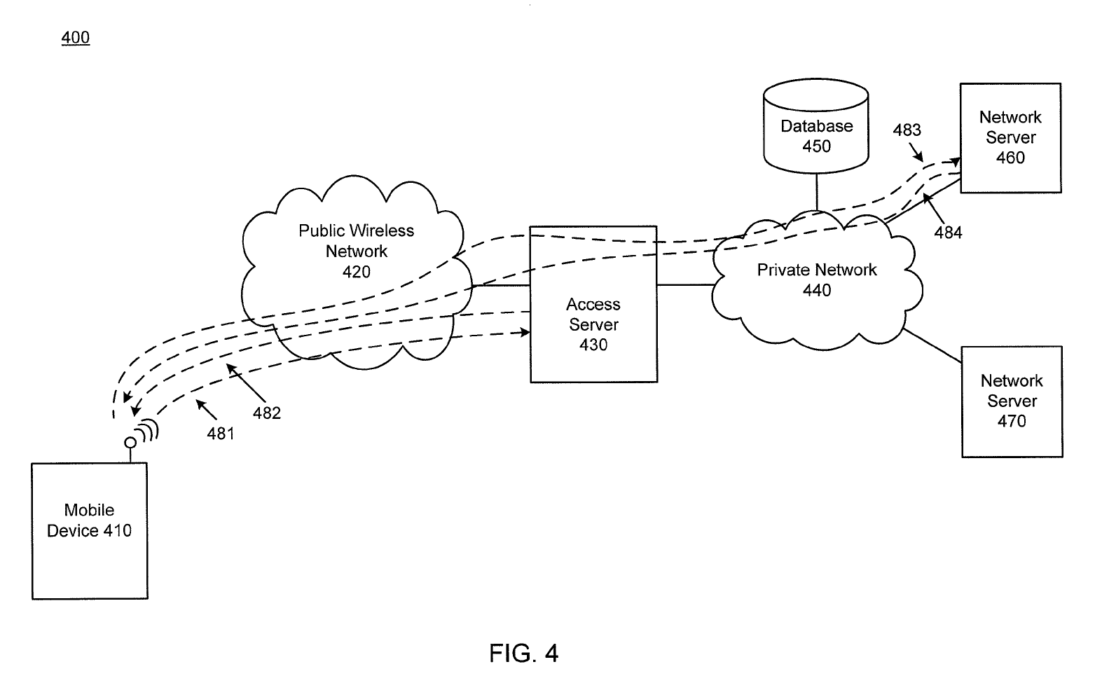

FIG. 4 is a schematic block diagram that illustrates a geolocation-based network access system, according to another embodiment. More specifically, FIG. 4 illustrates a network access system 400 including a mobile device 410 operatively (e.g., wirelessly) coupled to an access server 430 via a public wireless network 420. The access server 430 can be operatively and/or physically coupled to a private network 440, which can include and/or be coupled to a database 450, a network server 460 and a network server 470. In some embodiments, the network access system 400 can include multiple access servers similar to the access server 430, thereby providing multiple points of access to the private network 440 and/or one or more elements thereof or resources stored thereat. Although not shown in FIG. 4, the private network 440 can include and/or be operatively coupled to multiple databases, network servers and/or other network devices, peripherals or resources.

The mobile device 410 can be any mobile computing device, such as a mobile/cellular telephone, smartphone, tablet computing device, etc. In some embodiments, the mobile device 410 can be substantially similar to the mobile device 110 discussed in connection with FIG. 1 above, and/or to the mobile device 200 discussed in connection with FIG. 2 above. As shown in FIG. 4, the mobile computing device 410 can be operatively coupled and/or in communication with the access server 430 via the public wireless network 420. As further shown in FIG. 4, when granted access by the access server 430, the mobile device 410 can be in communication and/or can exchange data with one or more of the database 450, the network server 460 and the network server 470.

The public wireless network 420 can be any public cellular, Wi-Fi, WiMax or other wireless data network. In some embodiments, the public wireless network 420 can be substantially similar to the public wireless network 120 discussed in connection with FIG. 1 above.

The access server 430 can be any combination of hardware and/or software configured to regulate access of client devices (e.g., wireless devices such as the mobile device 410) to the private network 440. In some embodiments, the access server 430 can be a single server device, multiple server devices, a distributed service instantiated at multiple server devices, etc. In some embodiments, the access server 430 can be similar to the access server 130 discussed in connection with FIG. 1 above, and/or to the access server 300 discussed in connection with FIG. 3 above. As shown in FIG. 4, the access server 430 can optionally exchange signals and/or data with the mobile device 410 via the public wireless network 420. In some embodiments, the access server 430 can be configured to authorize the mobile device 410 for access to the private network 440 and/or to determine whether the mobile device 410 is authorized, based on a current geolocation of the mobile device 410, to access one or more network resources included in the database 450, the network server 460 and/or the network server 470. Although shown in FIG. 4 as a single device, in some embodiments functionality of the access server 430 can be included in one or more devices or elements of the private network 440. For example, one or more of the database 450, the network server 460, or the network server 470 can include access filtering functionality, such that a client device (e.g., the mobile device 410) can directly access a requested device or element when authorized by that device or element.

The private network 440 can be any private LAN, WAN, intranet, extranet or other private computing network associated with one or more entities, organizations, and/or the like. In some embodiments, the private network 440 can be substantially similar to the private network 140 discussed in connection with FIG. 1 above.

The database 450 can be any database or database server included in and/or operatively and/or physically coupled to the private network 440. In some embodiments, the database 450 can be similar to the private database 150 described in connection with FIG. 1 above. The database 450 can optionally store information associated with one or more mobile devices and/or users, such as the mobile device 410 and/or a user thereof. For example, the database 450 can store a device ID of the mobile device 410, a configuration hash value associated with and/or based at least in part on a hardware configuration and/or software configuration of the mobile device 410, etc. In some embodiments, the database 450 can store one or more lists of allowed and/or prohibited hardware components, software modules, software permissions, and/or combinations thereof In this manner, the database 450 can provide the access server 430 with information necessary to determine whether a mobile device is valid (and thus should be granted access to a requested resource included in the private network 440).

The database 450 can also optionally store information associated with a user of a mobile device, such as authentication information of that user. The authentication information can include, for example, username, password, biometric credential, password question/answer and/or other user authentication information.

In some embodiments, the database 450 can store geographic region, time period and/or other information associated with one or more network resources (e.g., files, folders, disk drives, storage units, applications, functions, commands, etc.). For example, the database 450 can store one or more sets of geographic coordinates configured to define one or more geographic regions from which a given network resource may be accessed. Alternatively, the one or more sets of geographic coordinates can define one or more geographic regions from which the given network resource may not be accessed. In some embodiments, the database 450 can store one or more time periods (e.g., times of day, dates, weeks, months, years, etc.) during which a given network resource may or may not be accessed by a client device (e.g., the mobile device 410). In this manner, the database 450 can store one or more combinations of geographic location and/or time such that a given mobile device (e.g., the mobile device 410) can only access one or more specified network resources when located within one or more predefined geographic regions during one or more predetermined times and/or dates.

The network servers 460 and 470 can be any combination of hardware and/or software configured to provide the access server 430 and/or a mobile device (e.g., the mobile device 410) with data, services, functionality and/or other network resources or features (e.g., applications, commands, etc.). In some embodiments, the network servers 460 and 470 can be similar to the network servers 160 and 170 described in connection with FIG. 1 above. Although not shown in FIG. 4, in some embodiments, any or both of the network servers 460 and 470 can be included in a single physical device as one another and/or another resource or element of the private network 440 (e.g., the access server 430, the database 450).

As shown in FIG. 4, the mobile device 410 can send a signal 481 to the access server 430 via the private wireless network 420. The signal can optionally be sent wirelessly, e.g., via a wireless cellular data and/or computer network. Alternatively, the signal can be sent via one or more other means, e.g., a wired Ethernet or coaxial cable network, a Bluetooth connection, an Ultra Wide Band (UWB) connection, a wireless Universal Serial Bus (wireless USB) connection, an Intel Thunderbolt connection, and/or the like. The signal 481 can include, for example, a request to access one or more network resources stored and/or available at the network server 460. For example, the request can include a request to access a cloud-based application executing at the network server 460 (such as a cloud-based e-mail, productivity, multimedia, messaging, or other application). Alternatively, the request can include a request to access a specified portion of data (e.g., a file, files, folder, database record, etc.), to execute a command at the network server 460, etc.

In some embodiments, the signal 481 can include authentication credentials associated with a current user of the mobile device 410. The authentication credentials can include, for example, a current geolocation of the mobile device 410. Upon receipt of the signal 481, the access server 430 can perform an authentication process associated with the user of the mobile device 410 and/or the mobile device 410 itself. As described in connection with FIG. 3 above, the authentication process can include verification of one or more user credentials by accessing, for example, a database such as the database 450. In some embodiments, the authentication process can include comparison of the current geolocation of the mobile device 410 with one or more geographic regions and/or coordinates associated with the requested one or more network resources. For example, if the request 481 includes a request to access a specified file that can only be accessed (1) by a user included in a predefined user group, and (2) when the requesting device is physically located within a predefined geographic region, the access server 430 can both determine whether one or more of the received authentication credentials is included in a set of authentication credentials associated with the predefined user group and determine whether the current geolocation of the mobile device 410 falls within the predefined geographic region. In some embodiments, if the access server 430 determines in the affirmative for requirements (1) and (2) above, the access server 430 can determine that the mobile device 410 is currently authorized to access the requested one or more network resources. If the access server 430 determines in the negative for either of requirements (1) or (2) above, the access server 430 can determine that the mobile device 410 is not currently authorized to access the requested one or more network resources.

Alternatively or additionally, the access server 430 can determine, based on one or more records associated with the one or more network resources, whether the current time (e.g., the time and date of transmission of the signal 481) falls within a predetermined time period associated with the one or more network resources. If the access server 430 determines that the current time falls within the predetermined time period, the access server 430 can determine that the mobile device 410 is currently authorized to access the requested one or more resources. If the access server 430 determines that the current time does not fall within the predetermined time period, the access server 430 can determine that the mobile device 410 is not currently authorized to access the requested one or more resources.

Having authenticated the user of the mobile device 410 and/or determined that the mobile device 410 is currently authorized to access the requested one or more network resources, the access server 430 can send a signal 482 to the mobile device 410 via the public wireless network 420. The signal 482 can include, for example, an indication that the user has been authenticated and/or that the mobile device 410 has been granted access the one or more requested network resources. Said differently, the signal 482 can include an indication that the mobile device 410 has been granted access to a network resource based on, for example, a current geolocation of the mobile device 410.

Upon receipt of the signal 482, the mobile device 410 can next send a signal to access the requested/desired network resource. More specifically, the mobile device 410 can send a signal 483 via the public wireless network 420 and the private network 440 to the network server 460. Although shown in FIG. 4 as passing through the access server 430, in some embodiments the signal 483 can be sent directly from the mobile device 410 to the network server 460 via one or more switching and/or routing elements of the private network 440 (not shown in FIG. 4).

When it receives the signal 483, the network server 460 can perform any appropriate operations and/or send any appropriate signals in response thereto. For example, if the signal 483 includes a request for new e-mail messages, the network server 460 can access one or more internal data stores and/or external data stores (e.g., the database 450) to determine any new e-mail messages associated with an indicated user account. Alternatively, if the signal 483 includes a request to save an indicated resource or file at a data store, the network server 460 can perform the operation using an internal/local and/or external data store included in or located outside the private network 440. Said differently, the network server 460 can, in response to the signal 483, provide functionality and/or data in response to one or more requests received from the mobile device 410.

As shown in FIG. 4, the network server 460 can send, to the mobile device 410, a signal in response to the signal 483. More specifically, the network server 460 can send the signal 484 to the mobile device 410 via the private network 440 and the public wireless network 420. The signal 484 can include, for example, requested e-mail messages responsive to the signal 483 and/or any other relevant data responsive to the signal 483. In some embodiments, the signal 484 can include one or more results and/or calculations associated with a command executed at the network server 460 in response to the signal 483. In this manner, the network server 460 can provide, to the mobile device 410, access to network services, functionality and/or data via a client-facing public network (e.g., the public wireless network 420).

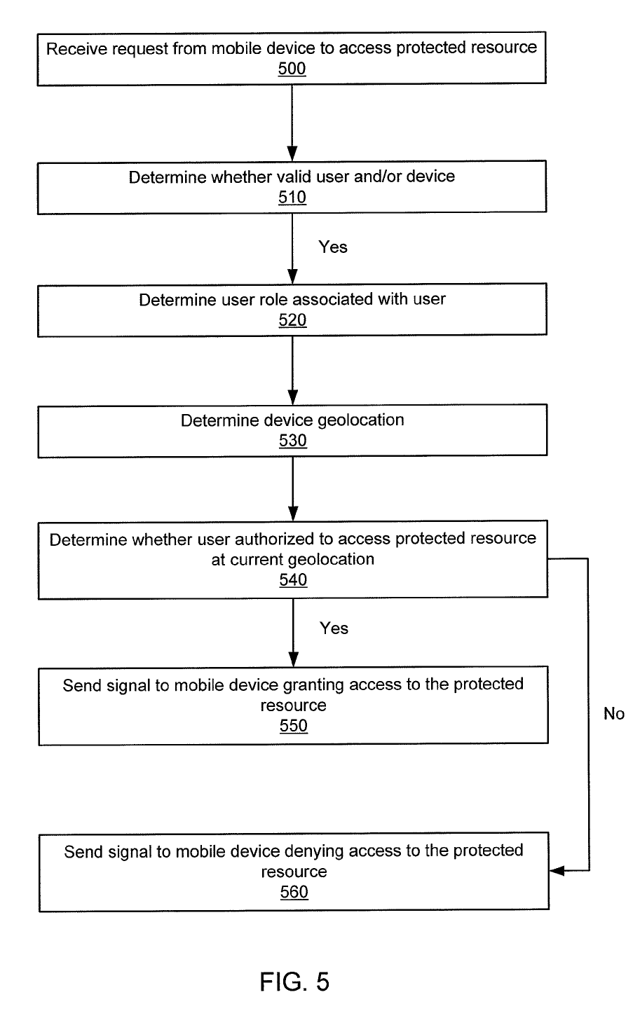

FIG. 5 is a flow chart describing a method of determining whether a mobile device is authorized to access a protected resource based on the mobile device's current geolocation, according to another embodiment. More specifically, FIG. 5 describes a method of determining whether a mobile device requesting access to a protected resource included in a private network is currently located in a region associated with the protected resource. By employing the method described in FIG. 5, a network device (e.g., an access server of a private network) can determine whether a requesting device should be granted access to a requested protected resource.

An access server can receive, from a mobile device, a request to access a protected resource, 500. The access server can be, for example, one or more hardware and/or software components and/or modules operatively and/or physically coupled to a private network (e.g., a company intranet, extranet, LAN, or WAN) and a public network (e.g., a public cellular or other wireless network owned and/or operated by a wireless data access provider). In some embodiments, the request can be included in a signal and can be formatted according to the Hypertext Transfer Protocol (HTTP) or other valid networking protocol. In some embodiments, the protected resource can be a file, file portion, folder, folder portion, datum, data portion, database, database row, database column, database record, command, instruction, or other resource or action associated with the private network.

The access server can authenticate the mobile device and/or a user thereof, 510. More specifically, the access server can receive, from the mobile device, a signal including one or more user credentials and/or credentials of the mobile device. The one or more user credentials can be or include, for example, a user ID, a username, a password, biometric credential, and/or the like associated with a current user of the mobile device. The one or more credentials of the mobile device can include, for example, a serial number, model number, telephone number, license key, Media Access Control (MAC) address, and/or other number or identifier sufficient to identify the mobile device. Upon receipt of the above-described user credentials and/or mobile device credentials, the access server can determine whether the current user and/or the mobile device is valid (e.g., whether the current user is associated with a valid user account associated with the private network and/or whether the mobile device has a valid configuration compatible with one or more protocols or requirements associated with the private network). For more information on device validation and/or device integrity checks, see co-pending application entitled “Multi-level, Hash-based Device Integrity Checks” (Attorney Docket TERR-001/01US), which is incorporated herein by reference. When the access server determines that the current user is associated with a valid user account and/or that the mobile device has a valid configuration, the access server can proceed to step 520, described below.

The access server can next determine a user role associated with the current user, 520. More specifically, based at least in part on the one or more received user credentials associated with the current user of the mobile device, the access server can determine one or more user roles and/or groups associated with a user account of the current user. For example, the access server can, based on a username of the user (and/or another user credential associated with the user), query a network database (e.g., a database similar to the database 450 of FIG. 4) to determine a user role associated with the user account. Based at least in part on this user role, the access server can determine a predetermined permission level, set of permissions, etc. associated with the user account. In some embodiments, the access server can query, reference and/or receive the above-described user role information via a separate device included in or external to the private network.

The access server can next determine a current geolocation of the mobile device, 530. More specifically, the access server can receive a signal from the mobile device including one or more geographic coordinates that indicate a current geographic location of the mobile device. In some embodiments, the access server can receive the this signal in response to a second request signal sent to the mobile device, the second request signal including a request for the one or more geographic coordinates. In some embodiments, the one or more geographic coordinates can include, for example, longitude, latitude and/or altitude coordinates that indicate and/or represent a current geographic (i.e., physical) location of the mobile device.

The access server can determine whether the current user is authorized to access the requested protected resource at the current geolocation, 540. To do so, the access server can compare the user role and/or user group of the user account (as determined in connection with step 520 above) with a specified access level, set of one or more user roles, set of one or more user groups, and/or other access setting associated with the protected resource. In some embodiments, the access server can receive this access setting information of the protected resource from a database, such as the database queried in connection with step 520 above and/or another database included in or operatively coupled to the private network.

When an access setting associated with the protected resource matches the user role, user group, and/or other characteristic or access level of the user account, the access server can determine that the user is authorized to access the protected resource. When the access server determines that the user is authorized to access the protected resource, the access server can proceed to step 550 described below. When an access setting associated with the protected resource does not match the user role, user group, and/or other characteristic or access level of the user account, the access server can determine that the user is not authorized to access the protected resource. When the access server determines that the user is not authorized to access the protected resource, the access server can proceed to step 560 below.

If the access server determines that the one or more user roles, user groups and/or other characteristic information associated with the user account matches or is associated with the access information of the protected resource, the access server can send, to the mobile device, a signal including an indication that the mobile device has been granted access to the protected resource, 550. Although not described in FIG. 5, upon sending this signal, the access server can send additional signals to the mobile device to facilitate and/or provide access to the protected resource. Alternatively, if the access server determines that the user is not authorized to access the protected resource, the access server can send, to the requesting mobile device, a signal indicating that the mobile device has been denied access to the protected resource, 560.

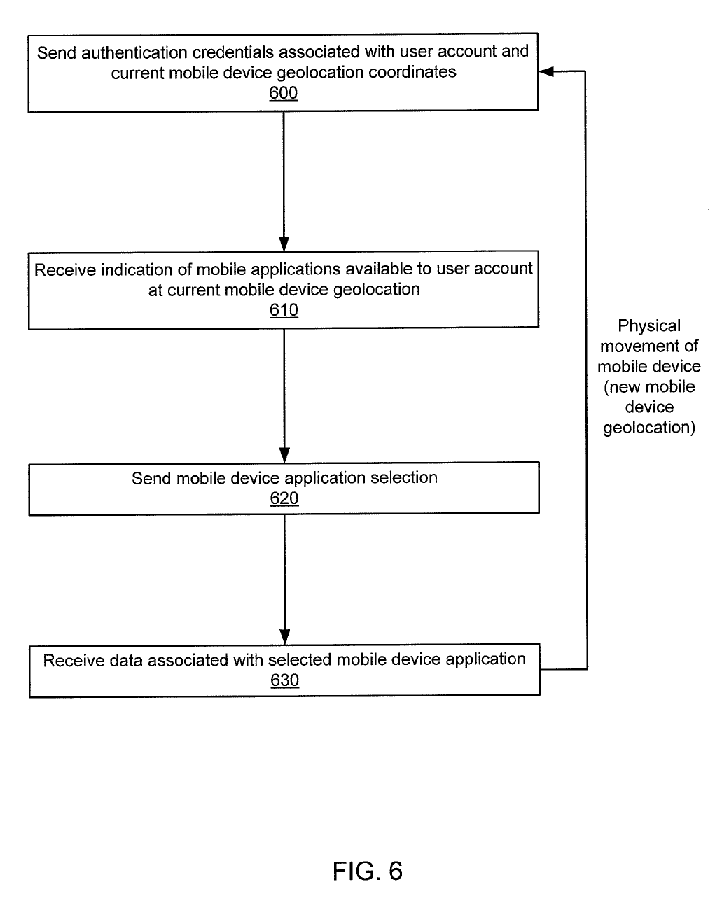

FIG. 6 is a flow chart describing a method of enabling functionality of a mobile device based at least in part on a current geolocation of the mobile device, according to another embodiment. More specifically, FIG. 6 describes a method of interacting with one or more mobile device applications enabled based at least in part on a current geolocation of the mobile device.

A mobile device can send an authentication credential associated with a user account and coordinates of a current geolocation of the mobile device, 600. In some embodiments, the mobile device can be any mobile computing device capable of determining its current geolocation and exchanging information with a public wireless network and/or a private wireless network. For example, the mobile device can be substantially similar to the mobile device 110 discussed in connection with FIG. 1 above. The authentication credential can be sent at the direction of a user of the mobile device, and can be, for example, a username, password, biometric credential, and/or other login credential. In some embodiments, the mobile device can send multiple authentication credentials, be it in a single signal or multiple signals. The current geolocation coordinates can optionally be determined, calculated and/or received by or at a geolocation device (e.g., a GPS module) included in and/or coupled to the mobile device. In some embodiments, the current geolocation coordinates can be updated according to a predetermined schedule and/or as received from an external source (e.g., one or more GPS satellites, a cellular network tower, a wireless data network node, etc.) In some embodiments, the mobile device can send the authentication credential and the current geolocation coordinates to a network device (e.g., a server device) associated with and/or included in a private network.

The mobile device can receive an indication of one or more mobile device applications associated with the user account and the current geolocation, 610. More specifically, the mobile device can receive one or more signals from the network device including, for example, description, icon, title, and/or other information associated with one or more mobile device applications that the user account is authorized to execute while within a predetermined geographic region in which the current geolocation is located. For example, the mobile device can receive an icon of a messaging application (e.g., an e-mail client application), along with an application title and/or description. Upon receipt of the this information, the mobile device can, for example, output the icon and/or title/description information at a display included in and/or coupled to the mobile device. In some embodiments, the mobile device can enable (i.e., make “clickable” and/or rendered as a colored icon) a disabled and/or “grayed-out” icon associated with the one or more mobile device applications. In this manner, the mobile device can display an indication (e.g., an icon, title and/or description) of one or more mobile device applications that a user of the mobile device (i.e., a user associated with the user account) can execute while within a current geographic area or region.

The mobile device can send a selection of the mobile device application, 620. More specifically, the mobile device can send, to a network device included in the private network, one or more signals including an indication and/or selection of one or more of the enabled mobile device applications described above. For example, in response to a user tap, click or other action indicating a selection of an enabled messaging application, the mobile device can send an indication to a network device configured to cause data associated with the messaging application to be sent to the mobile device. In the example, the indication can be configured to cause application files, code, resources and/or data (such as e-mail messages) associated with the messaging application to be sent to the mobile device by the network device. In some embodiments, the signal including the selection can be sent from a sole application executing at the mobile device. In such embodiments, the sole application can be a sole software application installed locally at the mobile device, the sole application configured to execute one or more network-based applications via interaction with one or more remote network servers.

The mobile device can next receive data associated with the selected mobile device application, 630. More specifically, the mobile device can receive, from a network device, a signal including any of the above-described information associated with the mobile device application, such as high-level code, binary code, executable binary files, resource libraries and/or user-specific data (e.g., e-mail messages, instant messages, etc.). In this manner, the mobile device can initialize the selected mobile device application, and can allow a user of the mobile device to interact with and/or utilize the mobile device application. For example, the mobile device can receive, from the network device, one or more secure messages (e.g., encrypted messages). In some embodiments, upon receipt of the one or more secure messages, the mobile device can send a signal to the network device including an indication that the one or more secure messages have been received and/or read. In such embodiments, the network device can, upon receipt of this confirmation signal, delete the one or more secure messages from the network device itself and/or an external memory or database at which they are stored.

As shown in FIG. 6, this interaction can include one or more subsequent receipts of information and/or resources included in the private network necessary to allow/enable a user of the mobile device to properly use the mobile device application.

In some embodiments, an enabled messaging application at the mobile device can receive, from a message server included in the private network, a set of one or more messages associated with a messaging account (e.g., a messaging account associated with the user account). In such embodiments, one or more of the messages can be received based at least in part on the current geolocation of the mobile device, and one or more other messages can be not received based at least in part on the current geolocation of the mobile device. The received one or more messages can include, for example, subject line information, sender information, message attachment information and/or data, and/or message text and/or body information.

As shown in FIG. 6, upon completion of step 630 described above, the mobile device can be physically moved to a new geolocation, different from the initial (“current”) geolocation described above. In such instances, the mobile device can be configured to send, to the network device, updated geolocation information (e.g., geographic coordinates) associated with the updated geolocation of the mobile device (based on, for example, a predetermined schedule, a received indication that the mobile device has moved, etc.).

In some embodiments, upon determination that the mobile device has moved outside a predetermined geographic region or area associated with the mobile device application, the mobile device can be configured to disable the icon associated with the mobile device application and/or otherwise disable selection, execution, access and/or use of the mobile device application. In such embodiments, the mobile device can be further configured to delete, erase and/or expunge data associated with the user account and/or the mobile device application when the mobile device determines that the current geolocation thereof is outside the predetermined geographic region described above. For example, the mobile device can be receive, from a network server, a signal including an instruction to delete one or more received messages (e.g., e-mail messages) when the mobile device has indicated to the network server that it is currently located is outside the predetermined geographic region with which those received messages are associated.

As further shown in FIG. 6, the transmission of this updated geolocation information can be represented by step 600 (albeit without the inclusion of authentication credential as described above). Thus, the process described in/represented by steps 610-630 can be repeated by the mobile device, for example, each time its geolocation changes and/or according to a predetermined time schedule, interval or period. As such, the mobile device can be configured to communicate with the network server to determine, for a given current geolocation of the mobile device, which mobile device applications are enabled for use by a user of the mobile device.

Some embodiments described herein relate to a computer storage product with a computer-readable medium (also can be referred to as a processor-readable medium) having instructions or computer code thereon for performing various computer-implemented operations. The media and computer code (also can be referred to as code) may be those designed and constructed for the specific purpose or purposes. Examples of computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), and read-only memory (ROM) and RAM devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

While various embodiments have been described above, it should be understood that they have been presented by way of example only, not limitation, and various changes in form and details may be made. Any portion of the apparatus and/or methods described herein may be combined in any combination, except mutually exclusive combinations. The embodiments described herein can include various combinations and/or sub-combinations of the functions, components and/or features of the different embodiments described. For example, a mobile device validation system can include multiple access servers configured to authenticate one or more mobile device users and/or to validate one or more client mobile devices.

What is claimed is:

1. A non-transitory processor-readable medium storing code representing instructions configured to cause a processor to:
receive, from a mobile device, a first signal including a request to execute a command at a server;
receive, from the mobile device, a second signal including a user credential associated with a user account;
determine, based on the user credential, a user role associated with the user account in response to the second signal;
receive, from the mobile device, a third signal indicating a geolocation of the mobile device;
determine, based at least on the user role and the geolocation, whether the user account is authorized to execute the command;
when the user account is authorized to execute the command, send a fourth signal such that the command is executed at the server.

2. The non-transitory processor-readable medium of claim 1, wherein the user account is authorized to execute the command during a first predetermined time period and the user account is not authorized to execute the command during a second predetermined time period.

3. The non-transitory processor-readable medium of claim 1, wherein the code further represents instructions configured to cause the processor to:
when the user account is authorized to execute the command, send a fifth signal to the mobile device including a result of the command.

4. The non-transitory processor-readable medium of claim 1, wherein the user credential is at least one of: a username, a password, or a biometric credential.

5. The non-transitory processor-readable medium of claim 1, wherein the code further represents instructions configured to cause the processor to:
determine, based at least in part on the user role and the user account, a permission group associated with the user account;
determine, based at least in part on the permission group, at least one set of data accessible by the user account; and
send a fifth signal including an indication of at least one set of data.

6. The non-transitory processor-readable medium of claim 1, wherein the geolocation is a first geolocation of the mobile device at a first time, and the code further represents instructions configured to cause the processor to:
send, based on a predetermined schedule, a fifth signal to the mobile device including a request for a second geolocation of the mobile device at a second time.

7. The non-transitory processor-readable medium of claim 1, wherein the code further represents instructions configured to cause the processor to:
when the user account is not authorized to execute the command, send a fifth signal to the mobile device indicating that the command has not been executed based at least in part on at least one of the user role or the geolocation.

8. A non-transitory processor-readable medium storing code representing instructions configured to cause a processor to:
send, to a server device, a first signal including (1) a credential associated with a user account and (2) a geolocation of a mobile device;
receive, in response to the first signal, a second signal including an indication of at least one application associated with the user account and the geolocation;
send, based on user input, a third signal including a selection of a first application from the at least one application; and
receive, in response to the third signal, a fourth signal including a first datum associated with the user account, the geolocation and the first application.

9. The non-transitory processor-readable medium of claim 8, wherein the first signal is sent from a sole application executing at the mobile device.

10. The non-transitory processor-readable medium of claim 8, wherein the code further represents instructions configured to cause the processor to:
enable a screen icon associated with the first application in response to the second signal.

11. The non-transitory processor-readable medium of claim 8, wherein the geolocation is a first geolocation of the mobile device at a first time, and the code further represents instructions configured to cause the processor to:
send a fourth signal when a second geolocation of the mobile device at a second time indicates that the mobile device is physically located outside a predetermined geographic region; and
erase data associated with the user account from the mobile device in response to the fourth signal.

12. The non-transitory processor-readable medium of claim 8, wherein the geolocation is a first geolocation of the mobile device at a first time, and the code further represents instructions configured to cause the processor to:
disable a screen icon associated with the first application when a second geolocation of the mobile device at a second time indicates that the mobile device is physically located outside a predetermined geographic region associated with the first geolocation.

13. The non-transitory processor-readable medium of claim 8, wherein the code further represents instructions configured to cause the processor to:
send a fifth signal including an updated geolocation of the mobile device, different from the geolocation of the mobile device, when a physical location of the mobile device changes; and
receive, in response to the fifth signal, an indication of a second application, the second application being associated with the updated geolocation, the user account and a current time.

14. A non-transitory processor-readable medium storing code representing instructions configured to cause a processor to:
receive, from a mobile device, a first signal including a request to receive messages associated with a user account;
receive, from the mobile device, a second signal indicating a geolocation of the mobile device;
determine, based on the geolocation and the user account, a first message from a set of messages associated with the user account and the geolocation; and
send, to the mobile device, a third signal including at least one of: a subject line of the first message, a sender of the first message, or a body of the first message.

15. The non-transitory processor-readable medium of claim 14, wherein the second signal further includes at least one of: a username associated with the user account, a password associated with the user account, or a biometric credential associated with the user account.

16. The non-transitory processor-readable medium of claim 14, wherein the request to receive messages is a first command from a plurality of commands associated with the user account and the geolocation, and a second command from the plurality of commands is configured to request that a second message from the plurality of messages be deleted.

17. The non-transitory processor-readable medium of claim 14, wherein the code further represents instructions configured to cause the processor to:
send, to the mobile device, a fourth signal including a secure message from the set of one or more messages;
receive, from the mobile device, a fifth signal indicating that the secure message has been received; and
delete, from a memory, the secure message in response to receiving the fifth signal.

18. The non-transitory processor-readable medium of claim 14, wherein the geolocation is a first geolocation of the mobile device at a first time, and the code further represents instructions configured to cause the processor to:
when a second geolocation of the mobile device at a second time indicates that the mobile device is physically located outside a predetermined geographic region associated with the first message and the user account, send, to the mobile device, a fourth signal such that all portions of the first message are deleted from the mobile device.

19. The non-transitory processor-readable medium of claim 14, wherein the code further represents instructions configured to cause the processor to:
prohibit a second message from the set of messages from being sent based at least in part on at least one of the geolocation and a current time.

20. The non-transitory processor-readable medium of claim 14, wherein the geolocation of the mobile device is a first geolocation of the mobile device at a first time, and the code further represents instructions configured to cause the processor to: when a second geolocation of the mobile device at a second time indicates that the mobile device is physically located within a predetermined geographic region, send, to the mobile device, a fourth signal including a second message from the set of one or more messages, the second message being associated with the second geolocation and not associated with the first geolocation.
